(19) United States
(12) Patent Application Publication
(10) Pub. No.: US 2009/0035434 A1
(43) Pub. Date: Feb. 5, 2009

(54) Method and Apparatus for Cutting Objects into Fixed Portions

(76) Inventors: Ragnar Sverrisson, Reykjavik (IS); Kristjan Hallvardsson, Kopavogur (IS)

Correspondence Address: NIXON & VANDERHYE, PC, 901 NORTH GLEBE ROAD, 11TH FLOOR, ARLINGTON, VA, 22203, US

(21) Appl. No.: 11/795,819

(22) PCT Filed: Jan. 24, 2006
(86) PCT No.: PCT/IS06/00002

§ 371 Date: Oct. 1, 2008

(30) Foreign Application Priority Data
Jan. 25, 2005 (IS) 7665

(51) Int. Cl. B26D 7/00; A23L 1/317; A22C 21/00

(52) U.S. Cl. 426/513; 99/537; 83/409

(57) ABSTRACT

The invention relates to a method and device for cutting objects, such as chicken breast in a portion with fixed weight and fixed shape. This is done by situating an object into a mould defining a predetermined shape, applying under-pressure in the mould for positioning the object in a fixed position, and cutting the part according to predetermined pattern depending on the desired end product.

### FIELD OF THE INVENTION

The present invention relates to a method and an apparatus for cutting objects into fixed portions, especially in the food industry.

### BACKGROUND

It is well known that raw materials are sold in predetermined portions, typically on the bases of weight and/or the shape of the raw material. For some products the weight and the shape of a single product is of crucial importance. This is for example the case when the product is a chicken breast, especially when the final product is for example a chicken sandwich, chicken burger, chicken fingers or chicken strips. This industry is growing extremely fast, and the demand for chicken breast products with a fixed shape and weight increases.

Mainly three methods are used when processing chicken breasts for this purpose:
a) Delivering the product directly to the customer without processing it further. Obviously this has the disadvantage that the pieces have different shapes as well as weight, as only a little part of the chicken breasts have the “right” weight and shape that fulfils the need set forth by the customer.
b) Manual processing of the chicken breast, which comprises cutting each peace in a fixed portion into a predetermined shape. This is however inaccurate method and requires a lot of manpower, which is expensive.
c) Automation processing, where the processing is based on two steps: providing a horizontal cut, thereby ensuring a right thickness of the product, and subsequently providing a vertical cut so that side parts of the breast are removed, by means of moving a cutting means, which is a high pressurised water jet, in a predefined path, defining thereby in-plane shape of the chicken breast. The problem with this latter method is how expensive it is, manpower demanding and requires very extensive mechanical maintenance as well as know how.

The invention of GB02364894 A discloses a computer controlled adjustable cutters for food. An image scanner (X-ray or visual spectrum) obtains a picture frame which is processed by a computer. The cutting path is determined by comparing the scanned three dimensional image map with a stored data. Preferably the product is rescanned after each cut. The food is turned or cut when it is transferred between two continuous belt conveyors. In one embodiment the food moves between the conveyors under vacuum. Preferably at least one conveyor has perforations. The apparatus includes three angled or adjustable, preferably fluid jet, rotating, oscillating, laser, band or ultrasonic cutters. The apparatus is used for cutting fish or meat.

The invention of WO 03079801A1 discloses a method and device for cutting objects such as chicken breasts in apportion with fixed weight and shape. This is done by situating an object into a mould defining a predetermined shape, applying under-pressure in the mould for positioning the object in a fixed position, and cutting the part of the object extending over the mould so that he remaining part of the object is essentially the part filling the mould.

U.S. Pat. No. 6,383,068B1 discloses an apparatus and method for portioning food items. The inventive apparatus preferably comprises: a carrier structure having a cavity provided therein for receiving a first portion of a food item; a holding device for imparting a force to the food item sufficient to hold the first portion of the food item in the cavity; and a saw or knife having a blade receivable between the carrier structure and the holding structure for cutting the food item into the first portion and a second portion. The holding structure is preferably an upper belt-type conveyor and the apparatus most preferably comprises a series of carrier plates conveyed by a lower conveyor system. Alternatively, the holding structure can be replaced with a vacuum system for generating a vacuum in the plate cavities. The inventive method comprises the steps of: (a) placing a first portion of a food item in a cavity provided in a holding structure; (b) pressing the food item, using a pressing structure, with a force sufficient to hold the first portion in the cavity; and (c) while pressing the food item, receiving a cutting structure between the holding structure and the pressing structure such that the cutting structure cuts the food item into the first portion and a second portion. In an alternative embodiment of the inventive method, the first portion of the food item is held by generating a vacuum in the cavity.

The prior art (U.S. Pat. No. 6,383,068) is capable of portioning automatically chicken breast into portions of like shape and weight. However, a new fashion food product has emerged on the marked called chicken fingers or chicken strips. The prior art does not solve the problem of producing these products in a consistent manner and without extensive manpower. Accordingly there is an urgent need, for low cost methods that requires limited manpower and know how for producing these products.

### DESCRIPTION OF THE INVENTION

It is an object of the present invention to provide a simple, cost effective device and method for cutting objects such as chicken breast into portions with a fixed shape and weight.

According to the first aspect the invention relates to a device for cutting objects into fixed portion size with a predetermined shape comprising:
a mould in which the object to be cut is situated in,
means for providing under-pressure in the mould for positioning the object in a fixed position, and
first cutting means for cutting the object into a main part and a supplementary part,
wherein the main part has a fixed portion size with a predetermined shape corresponding to the shape of the mould and the supplementary part corresponds to the difference between the object size and the portion size of the object,
second cutting means for cutting the object into at least two portions of predetermined sizes and shapes,
   wherein said mould further comprises, one or more guide means for guiding the second cutting means.

In one preferred embodiment the device comprises means for transferring the mould in a uniform motion during the cutting process, and wherein the first cutting means is positioned adjacent to the surface of the mould and is adapted to perform a cut parallel to the surface of the mould, while the second cutting means is positioned above the surface of the mould and adapted to make a cut at an angle above parallel to the surface.

The under pressure in the moulds may be provided through different implementations, such as by connecting each mould to a channel or air duct kept at constant under-pressure by the means of an external suction pump.

By mounting a plurality of moulds to a conveying unit in a continuous way a productive portioning device apparatus is formed, wherein the objects are cut into fixed portions with a fixed shape while the objects are being transferred in a uniform motion. The upper part of the conveying units may be defined as the processing part, where the objects are processed, and the lower part as the idle part. First cutting means may be a cutting blade, such as a rotating blade, positioned adjacent to the processing part of the conveying means. Other types of cutting means can be used. The second cutting means can be an array of at least one rotating cutting blade although other cutting means can be used.

The processing part of the conveyor belt is fed with objects to be processed. This may be done manually or automatically. The moving objects are situated and held in a fixed position in the mould by means of the under pressure. As the objects pass the first and second cutting means they are cut in a predetermined manner so that desired end product of fixed size and shape is obtained. The cutting pattern depends on the end product desired and there are three possible end products in four possible cutting configurations:
First cutting means only produces chicken breast portions of predetermined shape and size, and a supplementary part to be further processed.

First cutting means followed by the second cutting means produces chicken strips/chicken fingers of predetermined size and shape, and a supplementary part to be further processed.
Second cutting means followed by the first cutting means produces chicken strips/chicken fingers of predetermined size and shape, and supplementary parts to be further processed.
Second cutting means only produces chicken breast slices of predetermined thicknesses and no supplementary part.

In one embodiment an additional means is provided situated above the processing part for maintaining the object in a fixed position while it is being cut. This is to prevent a failure in the cutting, which could occur if for example the object does not fully cover the mould, which could cause an air leak to the surface of the mould and therefore reduce the under pressure at the surface of the mould. This additional means may be additional conveying unit with a conveyer belt, where a part of the belt is pressed against the upper part of the object while said object is being cut and thereby preventing said leak to the surface of the mould. This is however not an essential part in the present invention. The conveyor unit may as well be without said additional means.

Preferably, a removing board adapted to remove the supplementary part(s) of the object is mounted to the conveying unit, wherein said removed parts are transferred to a position where further processing is continued. If the removed parts are above minimum weight/size for an additional portion, they may be reprocessed, i.e. the process described here above may be repeated for those parts. The parts that however are under the minimum weight/size for such reprocess are used for other products, such as nuggets.

According to the second aspect, the present invention relates to a method for cutting objects into fixed portion size with a predetermined shape, said method comprising:
situating the object in a mould,
applying under-pressure in the mould for positioning and holding the object in a fixed position, and
cutting of the object into a main part and a supplementary part, wherein the main part has a fixed portion size with a predetermined shape and the supplementary part corresponds to the difference between the object size and the portion size of the object.
cutting the object at an angle above parallel with respect to the surface of the mould into at least two portions of predetermined sizes and shapes,
   wherein the order of cutting is not important, and the final portions each have predetermined size and shape according to the mould.

Preferably, the first cutting is performed parallel to the surface of the mould so that the portion size corresponds to the size of the object that fills out the mould and the portion shape to the shape of the mould, and the second cutting is performed substantially perpendicular to the first cut. In one embodiment the object is a chicken breast. Other types of products are also possible, such as meat and any types of poultry items.

### DETAILED DESCRIPTION

In the following the present invention, and in particular preferred embodiments thereof, will be described in greater details in connection with the accompanying drawings in which

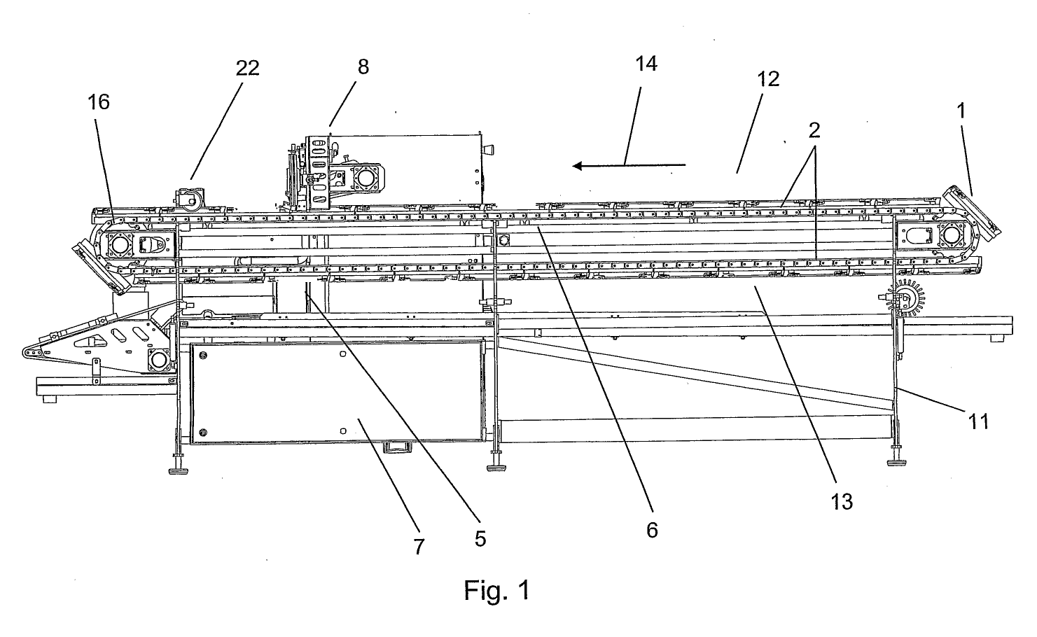

FIG. 1 shows a side view of the present invention,

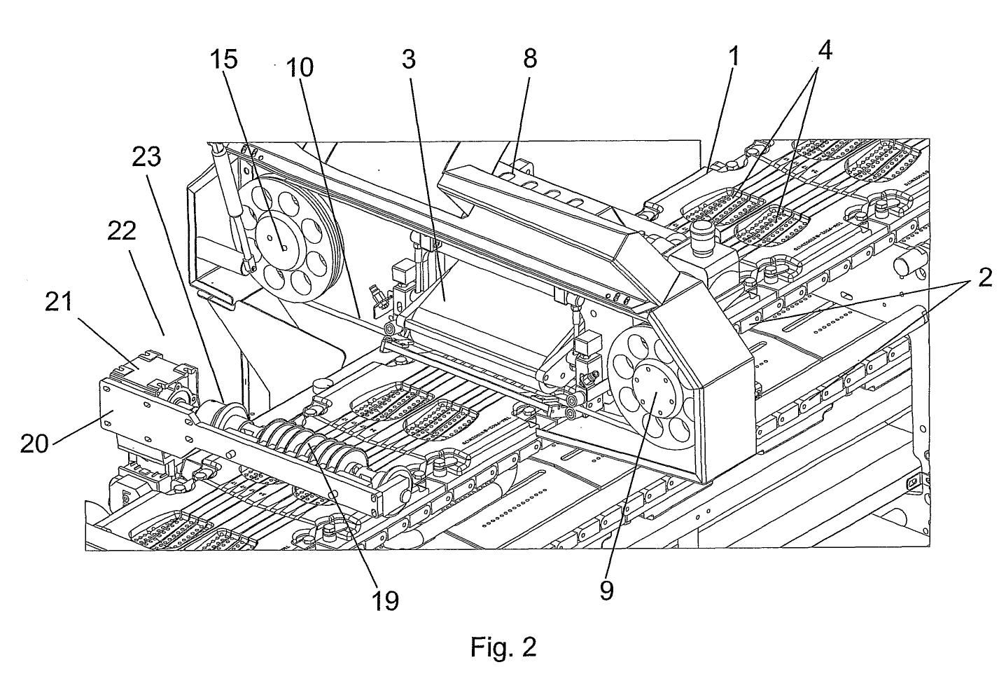

FIG. 2 shows a close-up view of the present invention focusing on the first and second cutting means as well as showing plurality of moulds mounted to the conveying means, and

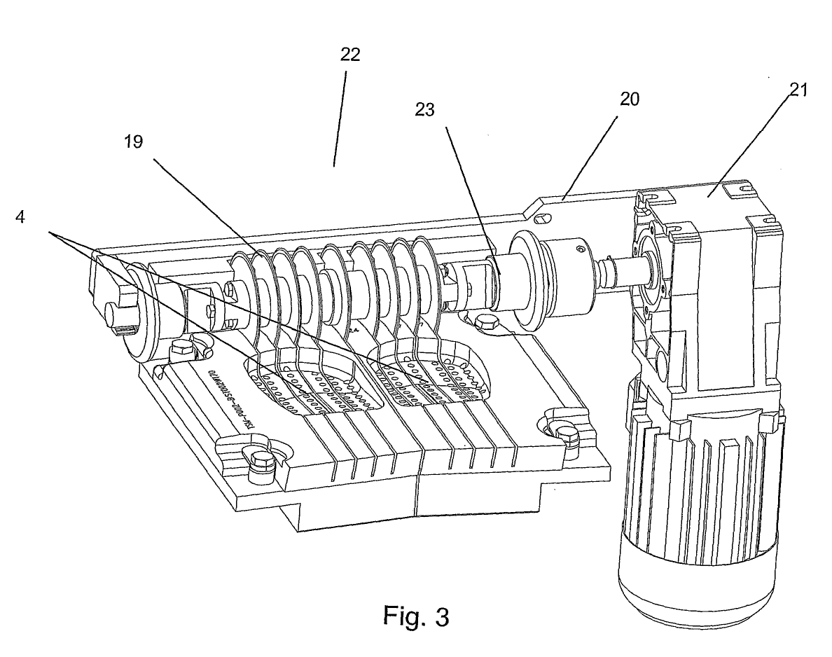

FIG. 3 shows the second cutting means, and

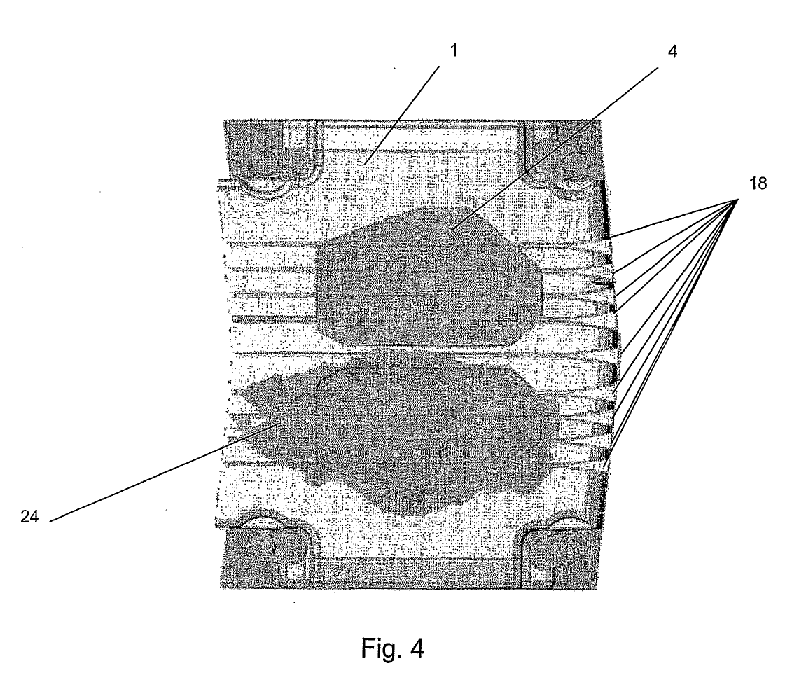

FIG. 4 shows a mould with two indentations, and

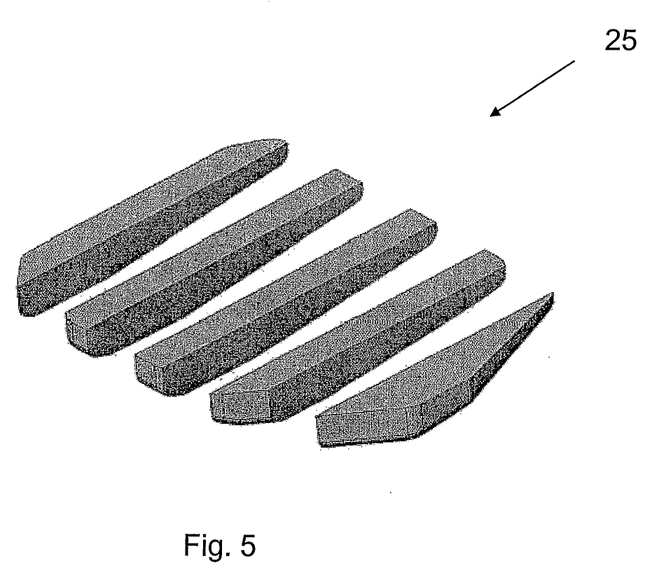

FIG. 5 shows the desired end product when both first and second cutting means are applied,

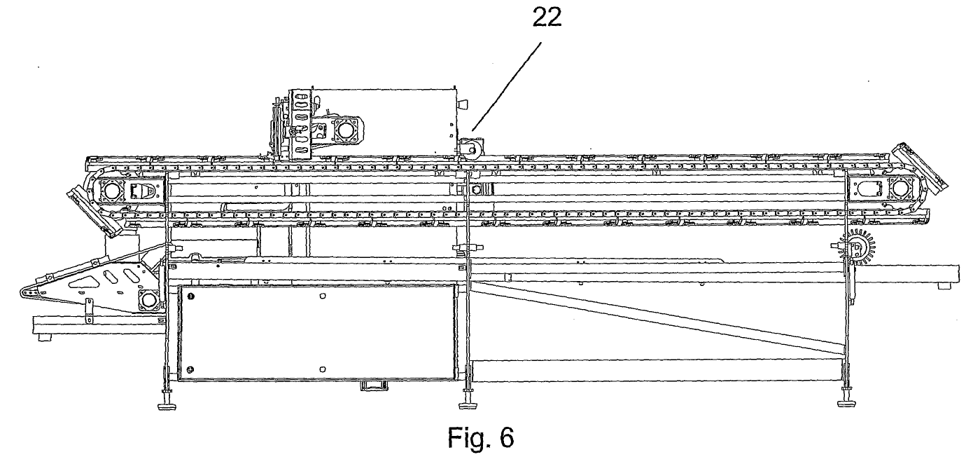

FIG. 6 shows side view of the present invention where the second cutting means is located up stream (before) the first cutting means.

FIG. 1 illustrates one embodiment of a conveyor supported by a frame 11 with a two chains 2 provided with a plurality of pins (not shown), adapted to slide into said engaging means of the mould 1 and therefore mounting the mould between the two chains as shown in FIG. 1. Other mounting methods are inherently possible for mounting the mould to a conveyor system.

By mounting a plurality of moulds 1 in the way described above, a conveyor unit is defined forming a single endless loop, which may be driven in a revolving manner by a driving unit 16 in a direction indicated by the arrow 14. The conveyor unit is furthermore equipped with supporting means 6 to support the plurality of moulds 1.

The upper part of the conveyor unit may be defined as the processing part 12, which is the part where the object is situated in the indentations 4 of the mould 1 (see FIG. 2) and cut. On the other hand the lower part may be defined as an idle part 13. Between the processing part 12 and the idle part 13 is a nozzle 5 which is further connected to a vacuum pump, or under-pressure unit 7 for providing under pressure. Any other kind of means for providing such under pressure could also be used. A first cutting means 8 is positioned adjacent to the processing part 12. A second cutting means 22 is shown down stream from the first cutting means 8, but could equally well be positioned up stream, before the first cutting means 8 as depict in FIG. 6.

FIG. 2 shows a close-up view of the present invention, focusing on the first 8 and the second 22 cutting means as well as showing plurality of mouldings 1 mounted to a conveying means A first cutting means 8 is positioned adjacent to the processing part 12 (see FIG. 1). An endless rotating cutting blade 10, is extended between two wheels 9 and 15, and positioned adjacent to the plane of the moulding 1, and used for cutting the part of the object extending over the indentations 4. In this embodiment an additional means 3 situated above the processing part may be provided for maintaining the object in a fixed position while it is being cut by the first cutting means. This is to prevent a failure in the cutting, which could occur if for example the object does not fully cover the indentations 4 of the mould 1 so that air leaks to the surface of the mould and reduces therefore the under pressure at the surface of the mould. This may be additional conveying unit (only the supporting frame is shown) with a conveyer belt, where in part, the belt is pressed against the upper part of the object while said object is being cut and thereby preventing said leak to the surface of the mould. This is however not an essential part in the present invention. The conveyor unit in FIG. 1 may as well be without said means 3.

FIG. 3 shows close up view of the second cutting means 22, which can be mounted with the bracket 20 to the frame 11 before or after the first cutting means 8 as shown in FIG. 1 and FIG. 6. The second cutting means 22 may be an array of rotating circular knives 19 mounted to the shaft 23, and propelled by the drive means 21. The array of knives 19 are guided by the guide means 18 (see FIG. 4) in the mould and cut the object at an angle above parallel to the surface of the indentations 4.

The cutting is performed while the objects are moving in a uniform motion in the direction indicated by the arrow 14 (see FIG. 1). The objects passing by the cutting means are cut in a predetermined manner so as to obtain one of the three end products previously discussed.

In FIG. 4, shows the unprocessed object 24. In one preferred application the end product could be chicken breast of fixed portions, in which case only the first cutting means would be applied. The part of the object that defines the fixed portion and shape is contained in the indentation 4 of the mould 1, and this part would be the end product in this case. In the case were the desired end product is chicken strips both cutting means must be applied although the order of cutting is irrelevant. However, the second cutting means are guided by the guides 18 of the housing 1, and produce end products 25 as depicted n FIG. 5. The end product in this case is the part that fills out the indentations 4 of the mould 1 sliced further in the direction of movement substantially perpendicular to the surface of the mould.

1. An apparatus for cutting meat objects into fixed portion sizes with a predetermined shapes comprising:
a mould in which the meat object to be cut is situated in,
means to provide under-pressure in the mould for positioning the meat object in a fixed position, and
first cutting means for cutting the meat object into a main part and a supplementary part, wherein the main part has a fixed size with a predetermined shape corresponding to the shape of the mould and the supplementary part corresponds to the difference between the meat object size and the size of the main part,
characterized in that a second cutting means mounted to a frame is provided for cutting said meat objects into at least two portions of predetermined sizes and shapes, wherein said mould further comprises, one or more guide means for guiding the second cutting means.

2. An apparatus according to claim 1, further comprising means for transferring the mould in a uniform motion during the cutting process.

3. An apparatus according to claim 1, wherein plurality of moulds are mounted to a conveying means in a continuous manner therefore defining a processing part as the upper section of the conveyor where the meat objects are situated in the moulds and processed, and an idle part as the lower section of the conveyor.

4. An apparatus according to claim 1, wherein the first cutting means is a cutting blade.

5. An apparatus according to claim 1, wherein the cutting blade is positioned adjacent to the surface of the mould and is adapted to perform a cut parallel to the surface of the mould.

6. An apparatus according to claim 1, wherein the first cutting means is positioned adjacent to the processing part of the conveying means and wherein the cutting is based on cutting the part of the meat object extending over the mould as it passes by the cutting blade.

7. An apparatus according to claim 1, wherein the first cutting means is a rotate-able cutting blade.

8. An apparatus according to claim 1, wherein the second cutting means is an array of one or more cutting blades.

9. An apparatus according to claim 1, wherein the array of cutting blades is positioned above the processing part of the conveying means and is adapted to perform the cutting at any angle above parallel with respect to the surface of the mould.

10. A method for cutting meat objects into multiple portions each of predetermined size and shape, said method comprising:
situating the meat object in a mould,
applying under-pressure in the mould for positioning the meat object in a fixed position, and
cutting the meat object into a main part and a supplementary part, wherein the main part has a fixed size with a predetermined shape corresponding to the shape of the mould and the supplementary part corresponds to the difference between the meat object size and the size of the main part,
cutting the meat object at an angle above parallel with respect to the surface of the mould into at least two portions of predetermined sizes and shapes,
wherein the order of cutting is not important, and the final portions each have predetermined size and shape according to the mould.

11. A method according to claim 10, wherein the size of the main part corresponds to the size of the meat object that fills out the mould.

12. A method according to claim 10, wherein the shape of the portions corresponds to the shape of the mould in one direction and the cutting guides in the mould in the other direction.

13. A method according to claim 10, wherein the meat object is chicken breast.

14. A method according to claim 10, wherein the first cutting is performed parallel to the surface of the mould, and the second cutting is performed at an angle substantially perpendicular to the surface of the mould.

15. A method according to claim 10, wherein the first cutting is performed at an angle substantially perpendicular to the surface of the mould, and the second cutting is performed parallel to the surface of the mould.
